(19) United States
(12) Patent Application Publication
(10) Pub. No.: US 2002/0184512 A1
(43) Pub. Date: Dec. 5, 2002

(54) Method and apparatus for supporting remote configuration to facilitate subscriber management

(76) Inventor: Augusto C. Cardoso JR., Oakland, CA (US)

Correspondence Address: PARK, VAUGHAN & FLEMING LLP, 508 SECOND STREET, SUITE 201, DAVIS, CA, 95616, US

(21) Appl. No.: 09/872,622

(22) Filed: May 31, 2001

(51) Int. Cl. G06F 12/14

(52) U.S. Cl. 713/193; 380/233

(57) ABSTRACT

One embodiment of the present invention provides a system that facilitates remotely configuring a device across a network. The system operates by receiving configuration information at the device from a remote system across the network. Next, the system encrypts this configuration information using a device key, which is locally stored at the device and is different from keys associated with other devices. The system then configures the device by storing the encrypted configuration information in a non-volatile configuration store associated with the device. In this way, the encrypted configuration information contained in the non-volatile configuration store cannot be used with another device. In one embodiment of the present invention, receiving the configuration information involves using a secret key, which is locally stored at the device, to decrypt the configuration information received from the remote system. In one embodiment of the present invention, the device key is stored in a one-time programmable memory within the device that can be programmed only once and cannot be reprogrammed.

### BACKGROUND

1. Field of the Invention

The present invention relates to a system for configuring a remote device across a network. More specifically, the present invention relates to a method and an apparatus for configuring a remote device to facilitate subscriber management.

2. Related Art

As new media technologies continue to proliferate, people are increasingly willing to pay subscription fees for access to content. Monthly cable bills and Internet access bills are becoming as common as other household expenditures, such as utility bills and telephone bills. Unfortunately, existing distribution systems for this type of content have a number of shortcomings.

It is very cumbersome manage subscribers with existing distribution systems. If a subscriber fails to pay a monthly bill, a cable company typically has to send a service technician out to a remote location in order to disable or reconfigure cable access for the subscriber. A technician visit is also required to add a new subscriber or to change the service level of a subscriber.

Piracy is also a problem. In existing systems, a transceiver that is used to de-scramble a scrambled signal can typically be replicated or modified to allow a rogue user to access broadcast content without paying. Note that such transceivers can be easily obtained, and thousands of technicians who are employed or were formerly employed by access providers have the knowledge to perform such modifications.

In order to remedy these shortcomings, some access providers have begun to develop systems that use smart cards and other mechanisms to restrict access to content. However, combining smart cards and other mechanisms into distribution systems can be expensive. Furthermore, even with such mechanisms, distribution systems may still be susceptible to certain types of tampering.

Moreover, note that it is particularly challenging to remotely manage conditional accesses mechanisms through a broadcast channel that provides only one-way communication from the access provider to the subscriber.

What is needed is an efficient and low-cost mechanism for configuring a remote device to facilitate subscriber management.

### SUMMARY

One embodiment of the present invention provides a system that facilitates remotely configuring a device across a network. The system operates by receiving configuration information at the device from a remote system across the network. Next, the system encrypts this configuration information using a device key, which is locally stored at the device and is different from keys associated with other devices. The system then configures the device by storing the encrypted configuration information in a non-volatile configuration store associated with the device. In this way, the encrypted configuration information contained in the non-volatile configuration store cannot be used with another device.

In one embodiment of the present invention, receiving the configuration information involves using a secret key, which is locally stored at the device, to decrypt the configuration information received from the remote system.

In one embodiment of the present invention, the device key is stored in a one-time programmable memory within the device that can be programmed only once and cannot be reprogrammed.

In one embodiment of the present invention, receiving the configuration information involves using a public key of the remote system to validate that the configuration information was digitally signed by a corresponding private key belonging to the remote system.

In one embodiment of the present invention, the device uses the configuration information to control access to a stream of content in order to facilitate subscriber management.

In one embodiment of the present invention, the configuration information includes either a fixed key or a variable key for decompression and/or decryption of the stream of content.

In one embodiment of the present invention, the device can include: a computer, a personal digital assistant, a network interface, a cable television interface, a satellite television interface, or a network router.

In one embodiment of the present invention, the network can include a local area network, a wide area network, or a wireless network.

In one embodiment of the present invention, configuring the device can involve enabling or disabling the device.

In one embodiment of the present invention, the device is embodied in an integrated circuit.

### BRIEF DESCRIPTION OF THE FIGURES

FIG. 1 illustrates a remotely configurable device in accordance with an embodiment of the present invention.

FIG. 2 is a flow chart illustrating the process of initially programming the device in accordance with an embodiment of the present invention.

FIG. 3 is a flow chart illustrating the process of configuring the device in accordance with an embodiment of the present invention.

FIG. 4 is a flow chart illustrating how the device is used to restrict access to a stream of content in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Remotely Configurable Device

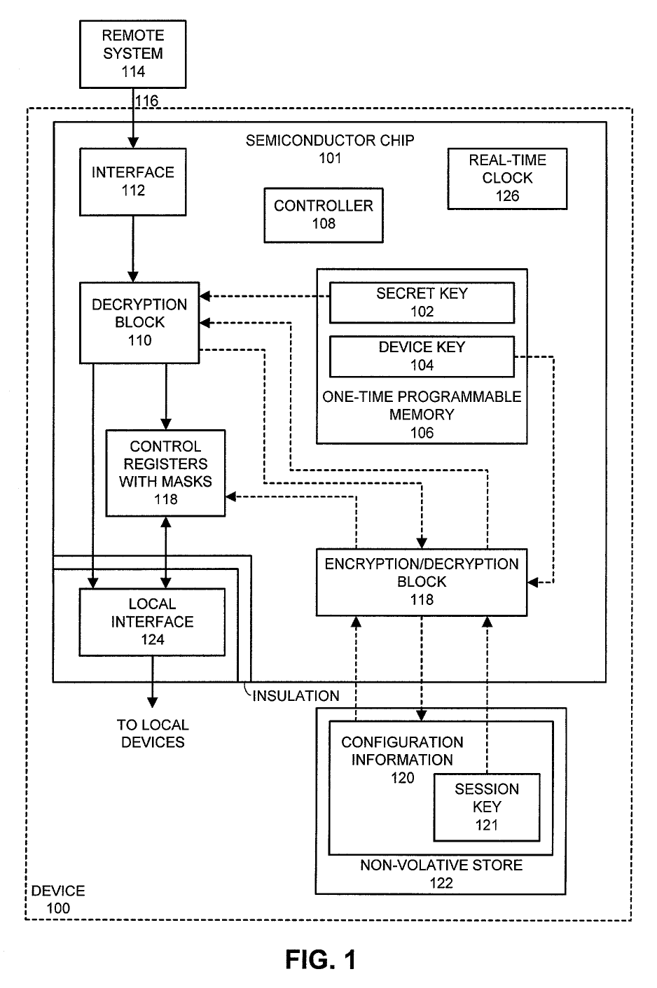

FIG. 1 illustrates a remotely configurable device 100 in accordance with an embodiment of the present invention. As is illustrated in FIG. 1, device 100 receives a broadcast transmission 116 from a remote system 114.

Device 100 can generally include any type of device or system that can be remotely programmed, including a network router, an appliance, a video game player, a computer system, a personal digital assistant, a cable transceiver or a satellite transceiver. Note that broadcast transmission 116 can generally include any type of broadcast transmission, including a satellite transmission, a cable transmission, or a free air transmission. Furthermore, broadcast transmission 116 can generally include any type of content, including audio-visual content as well as unicast or multicast Internet Protocol (IP) transmissions. Moreover, remote system 114 can include any type of system that can produce a broadcast transmission.

Broadcast transmission 116 is received at an interface 112 within device 100. Interface 112 can generally include various transceivers, tuners and/or demodulators for capturing broadcast transmission 116.

From interface 112, broadcast transmission 116 feeds into semiconductor chip 101. Within semiconductor chip 101, broadcast transmission 116 feeds into decryption block 110, which decrypts broadcast transmission 116 (if necessary) using session key 121. The decrypted broadcast transmission 116 is then passed through local interface 124 to local devices that make use of the content within broadcast transmission 116.

Configuration information 120 can also be received through broadcast transmission 116. Configuration information 120 can be decrypted at decryption block 110 using a secret key 102, which is unique to semiconductor chip 101. This decrypted configuration information 120 can then be re-encrypted in encryption/decryption block 118 using device key 104, which is also unique to semiconductor chip 101. Re-encrypted configuration information 120 can then be stored in non-volatile store 122, which is external to semiconductor chip 101. Note that this encryption and decryption can be accomplished through any of a number of known techniques, such as 3DES (Triple Data Encryption Standard). Also note that non-volatile store 122 can include any type of non-volatile memory, such as EPROM (Electrically Programmable Read Only Memory), flash memory, magnetic storage or optical storage.

Device secret key 102 is known only to remote system 114 and semiconductor chip 101. Hence, by encrypting and broadcasting a command using secret key 102, remote system 114 can target only device 100 to receive the command.

Furthermore, since device key 104 is known only to device 100, and not to other devices, configuration information 120 within non-volatile store 122 can only be used with semiconductor chip 101 and cannot be used with other semiconductor chips. Hence, even if configuration information 120 is copied from non-volatile store 122, it cannot be used with another device.

Secret key 102 and device key 104 are stored in one-time programmable memory 106 within semiconductor chip 101. One-time programmable memory 106 has the property that it can be programmed only once and cannot be reprogrammed. For example, one-time programmable memory 106 can include a PROM (programmable read only memory) or a battery backed up RAM. Note that the contents of a battery backed up RAM disappears if power is interrupted.

Decryption block 110 may also include a validation mechanism that uses a public key to validate that a digital signature accompanying configuration information 120 was produced using a private key belonging to a trusted party.

Configuration information 120 can generally include any type of configuration information for device 100, such as a fixed session key or variable session key 121 for decrypting broadcast transmission 116. Note that a variable session key is generally valid for a period of time determined with respect to a real-time clock 126 located on semiconductor chip 101 and powered by a local battery, or alternatively, with reference to a time signal that is sent from remote system 114 through broadcast transmission 116. Additionally, note that session key 121 is decrypted in block 118 before being used by decryption block 110 to decrypt broadcast communication 116.

Configuration information 120 can include information that enables or disables access to certain channels available in broadcast transmission 116. In one embodiment of the present invention, configuration information 120 can completely enable or disable device 100.

Configuration information 120 can also be used to set masks that indicate which bits within control registers 118 can be read from and/or written to. Note that semiconductor chip 101 includes a number of control registers 118 that control various functions within semiconductor chip 101. These control registers 118 can be configured by remote system 114. Remote computer system 114 can cause configuration information to be loaded into control registers 118. Moreover, by setting appropriate mask bits associated with control registers 118, remote system 114 is able to make some of these registers accessible through local interface 124.

Note that local interface 124 is insulated from the rest of semiconductor chip 101, so that it is impossible to read from or write to secret key 102, device key 104, or configuration information 120 through local interface 124. This prevents a user of device 100 from gaining access to secret key 102, device key 104, or configuration information 120.

Also note that the above-described mechanisms within semiconductor chip 101 are controlled by controller 108. Controller 108 can include any type of circuitry that can be used to implement control functions. For example, controller 108 can include a microprocessor within semiconductor chip 101.

Initial Programming

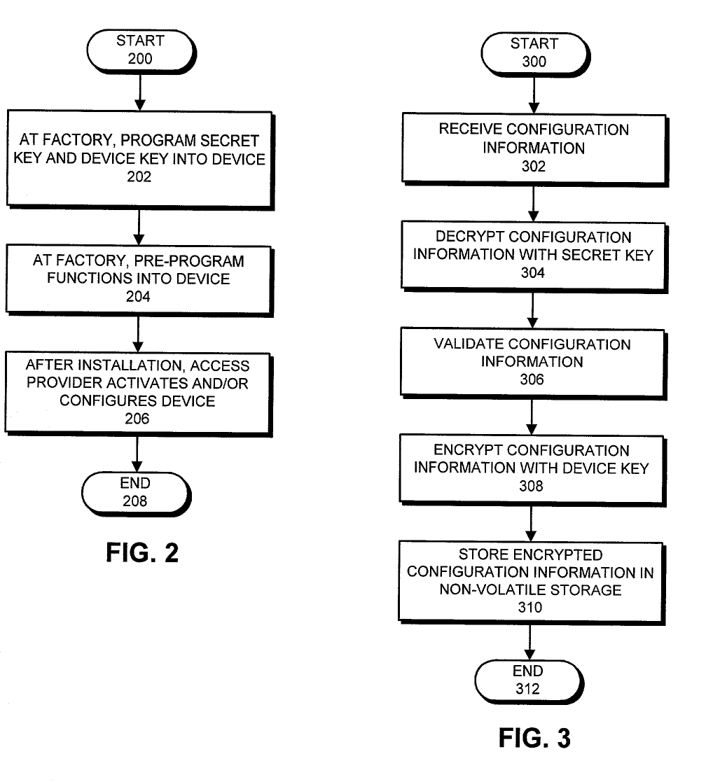

FIG. 2 is a flow chart illustrating the process of initially programming device 100 in accordance with an embodiment of the present invention. At the factory, a unique secret key 102 is first obtained for semiconductor chip 101, and is then programmed into one-time programmable memory 106. Secret key 102 is also shared with remote system 114 so that remote system 114 can use secret key 102 to communicate with device 100. A unique device key 104 is also obtained for semiconductor chip 101, and is then programmed into one-time programmable memory 106 (step 202). The programmability of one-time programmable memory 106 is subsequently disabled so it cannot be reprogrammed.

In an optional step, device 100 can be pre-programmed at the factory to initially operate in a restricted access mode (step 204).

After installation, an access provider sends a broadcast transmission 116 to device 100 in order to configure device 100 (step 206). This configuration process is described in more detail below with reference to FIG. 3.

Configuring Device

FIG. 3 is a flow chart illustrating the process of configuring device 100 in accordance with an embodiment of the present invention. During the configuration process, device 100 receives configuration information 120 through broadcast transmission 116 (step 302). Device 100 then decrypts configuration information 120 using secret key 102 from one-time programmable memory 106 (step 304). Device 100 can also use a public key to validate a digital signature accompanying configuration information 120 to ensure that configuration information 120 was signed with a corresponding private key belonging to a trusted entity (step 306).

Next, the system encrypts configuration information 120 using device key 104 (step 308), and then stores the encrypted configuration information 120 in non-volatile store 122 (step 310).

Restricting Access with the Device

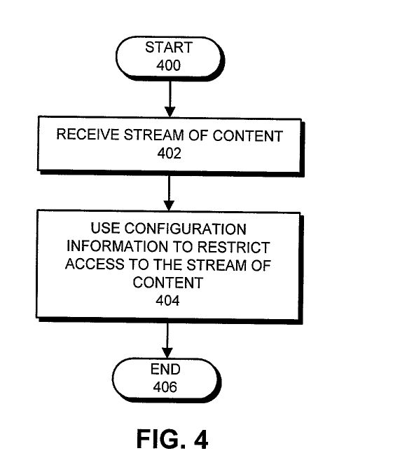

FIG. 4 is a flow chart illustrating how the device is used to restrict access to a stream of content in accordance with an embodiment of the present invention. Device 100 first receives a stream of content through broadcast transmission 116 (step 402). Device 100 then uses configuration information 120 to selectively restrict access to certain channels available through broadcast transmission 116 (step 404).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for remotely configuring a device across a network, comprising:
receiving configuration information at the device from a remote system across the network;
encrypting the configuration information using a device key, wherein the device key is locally stored at the device and is different from keys associated with other devices; and
configuring the device by storing the encrypted configuration information in a non-volatile configuration store associated with the device;
whereby the encrypted configuration information contained in the non-volatile configuration store cannot be used with another device.

2. The method of claim 1, wherein receiving the configuration information involves using a secret key, which is locally stored at the device, to decrypt the configuration information received from the remote system.

3. The method of claim 1, wherein receiving the configuration information involves using a public key of the remote system to validate that the configuration information was digitally signed by a corresponding private key belonging to the remote system.

4. The method of claim 1, wherein the device key is stored in onetime programmable memory within the device that can be programmed only once and cannot be reprogrammed.

5. The method of claim 1, wherein the device uses the configuration information to control access to a stream of content in order to facilitate subscriber management.

6. The method of claim 5, wherein the configuration information includes either a fixed key or a variable key for decompression and/or decryption of the stream of content.

7. The method of claim 1, wherein the device includes one of:
a computer;
a personal digital assistant;
a network interface;
a cable television interface;
a satellite television interface; and
a network router.

8. The method of claim 1, wherein the network includes one of:
a local area network;
a wide area network; and
a wireless network.

9. The method of claim 1, wherein configuring the device can involve enabling or disabling the device.

10. The method of claim 1, wherein the device is embodied in an integrated circuit.

11. An apparatus that facilitates remotely configuring a device across a network, comprising:
an interface, at the device, that is configured to receive configuration information from a remote system across the network;
an encryption mechanism that is configured to encrypt the configuration information using a device key, wherein the device key is locally stored at the device and is different from keys associated with other devices; and
a configuration mechanism that is configured to store the encrypted configuration information in a non-volatile configuration store associated with the device;
whereby the encrypted configuration information contained in the non-volatile configuration store cannot be used with another device.

12. The apparatus of claim 11, further comprising a decryption mechanism that is configured to use a secret key, which is locally stored at the device, to decrypt the configuration information received from the remote system through the interface.

13. The apparatus of claim 11, further comprising a validation mechanism that is configured to use a public key of the remote system to validate that the configuration information was digitally signed by a corresponding private key belonging to the remote system.

14. The apparatus of claim 11, further comprising a one-time programmable memory within the device for storing the device key;
wherein the one-time programmable memory can be programmed only once and cannot be reprogrammed.

15. The apparatus of claim 11, further comprising a content screening mechanism that is configured to use the configuration information to control access to a stream of content in order to facilitate subscriber management.

16. The apparatus of claim 15, wherein the configuration information includes either a fixed key or a variable key for decompression and/or decryption of the stream of content.

17. The apparatus of claim 11, wherein the device includes one of:
a computer;
a personal digital assistant;
a network interface;
a cable television interface;
a satellite television interface; and
a network router.

18. The apparatus of claim 11, wherein the network includes one of:
a local area network;
a wide area network; and
a wireless network.

19. The apparatus of claim 11, wherein the configuration mechanism can enable and/or disable the device.

20. The apparatus of claim 11, further comprising an integrated circuit upon which the device is embodied.

21. The apparatus of claim 11, wherein the interface is configured to support one-way communication from the remote system to the device.

22. The apparatus of claim 11, further comprising a local interface on the device for communicating with local resources;
wherein the local interface is insulated from the configuration information stored in the non-volatile configuration store, so that it is impossible to access the configuration information through the local interface.

23. An apparatus that facilitates remotely configuring a device across a network, comprising:
an interface, at the device, that is configured to receive configuration information from a remote system across the network;
a decryption mechanism that is configured to use a secret key, which is locally stored at the device, to decrypt the configuration information received from the remote system through the interface;
an encryption mechanism that is configured to encrypt the configuration information using a device key, wherein the device key is locally stored at the device and is different from keys associated with other devices; and
a configuration mechanism that is configured to store the encrypted configuration information in a non-volatile configuration store associated with the device; and
a one-time programmable memory within the device for storing the device key and the secret key, wherein the one-time programmable memory can be programmed only once and cannot be reprogrammed;
whereby the encrypted configuration information contained in the non-volatile configuration store cannot be used with another device.

24. The apparatus of claim 23, further comprising a content screening mechanism that is configured to use the configuration information to control access to a stream of content in order to facilitate subscriber management.

25. The apparatus of claim 23, further comprising a validation mechanism that is configured to use a public key of the remote system to validate that the configuration information was digitally signed by a corresponding private key belonging to the remote system.
